(19) United States
(12) Patent Application Publication
(10) Pub. No.: US 2003/0137155 A1
(43) Pub. Date: Jul. 24, 2003

(54) Adjustable door guide latch slot assembly

(75) Inventor: Rich Baranski, Phoenix, AZ (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: U-Haul International, Inc.

(21) Appl. No.: 10/055,757

(22) Filed: Jan. 22, 2002

(51) Int. Cl. E05B 15/02

(52) U.S. Cl. 292/341.18

(57) ABSTRACT

An adjustable door guide latch slot assembly for aligning a slidable door latch with a fixed door guide includes a striker plate having a latch opening and a door guide having an inner surface with a recessed area on such inner surface, said recess area being larger than said striker plate and having an opening therein, whereby said striker plate may be placed flat against said door guide inner surface in said recessed area and adjustably affixed to said door guide inner surface so that said striker plate latch opening may be made to align properly with said slidable door latch.

### FIELD OF THE INVENTION

The present invention relates generally to door latches and, more particularly, to a door guide latch slot assembly that may be adjusted to compensate for height variations in door hardware installations.

### BACKGROUND OF THE INVENTION

A large number of commercial and residential buildings and facilities use vertically sliding overhead doors for a variety of applications such as garage doors, exterior doorways, and doorways into storage rooms. Such overhead doors come in a wide array of sizes and may be opened and closed either manually or with an electric motor. Typically, these overhead doors travel in door frames or door guides that are permanently affixed to the material of the walls that form the doorway or other opening covered by the overhead door when the overhead door is in a closed position. The overhead doors move vertically up and down between the door guides and are typically counterbalanced with some type of spring mechanism to facilitate their movement. Additionally, rollers are often placed on the outer edges of the overhead doors in contact with the inner surface of the door guides to facilitate the up and down movement of the overhead doors.

When in a closed position, such overhead doors are often latched shut by a slidable latch mechanism. The latch mechanism is permanently affixed to the vertical door and, when in a closed position, has a slidable latch tongue that passes through an opening in the door guide. To be effective, the door guide opening through which the latch tongue passes is typically the same general shape as the latch tongue cross-section and only slightly larger than that cross-section so as to achieve a secure fit between the latch tongue and the door guide opening.

The need for a secure fit between the latch tongue and the door guide opening through which the latch tongue passes when the latch is in a closed or locked position is frequently hindered by height variations between the installation of the door guide and the overhead door. Even very slight variations in the installation of this hardware can result in situations where the latch tongue will not line up with the door guide opening, thereby preventing the latch tongue from being moved into its closed position.

Accordingly, a need exists for an adjustable door guide latch slot assembly mechanism to compensate for door hardware installation height variations that would otherwise prevent proper operation of a slidable door latch mechanism. Moreover, a need exists for an adjustable door guide latch slot assembly that will be easy to install and will not interrupt the smooth operation of the vertical door with which it is associated.

### SUMMARY OF THE PREFERRED EMBODIMENTS

An adjustable door guide latch slot assembly is disclosed. The latch slot assembly preferably includes a door guide having an opening therein that is larger than the latch tongue intended to be used to lock a vertical sliding door in its closed position. The door guide has an inner and an outer surface and the door guide opening is located in a portion of the door guide which, when viewed from the inner surface, is recessed from the rest of the inner surface of the door guide. The latch slot assembly also includes a striker plate that is adjustably mounted on the inner surface of the door guide and has a thickness that is less than or equal to the depth of the recessed area on the inner surface of the door guide. In a preferred embodiment, the striker plate has an opening that is of a size and shape to present a secure fit for the latch tongue on a slidable latch mechanism on a vertical door. The door guide opening is equipped with cut-out slots at either end of the opening to allow for adjustment of the position of fasteners used to affix the striker plate to the inner surface of the door guide. When properly positioned in the recessed portion of the inner surface of the door guide, the striker plate opening is precisely aligned with the vertical door latch tongue and the striker plate fills the remainder of the door guide opening. Further, because the striker plate is placed in a recessed portion of the door guide, it does not interfere with any rollers that may be present on the outer edges of the vertical door and therefore facilitates the smooth operation of the vertical door.

In addition, the door guide latch slot assembly may be equipped with a security device, such as an electromechanical alarm, that is affixed to the striker plate from the door guide outer surface and through the door guide opening. The security device has a latch tongue receiving port that is aligned with the striker plate latch tongue opening so that the latch tongue, when in a closed position, passes through the striker plate opening and into the security device receiving port so as to engage the security device. Adjustment of the striker plate position automatically results in proper adjustment of the security device latch tongue receiving port.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is an illustration of a preferred embodiment of the door guide latch slot assembly of the present invention in an unassembled configuration;

FIG. 2 is an illustration of a door guide and vertical door slidable latch assembly with the latch tongue extended into a closed position;

FIG. 3 is an illustration of the door guide latch slot assembly of the present invention in a partially assembled configuration and with a centered striker plate.

FIG. 4 is an illustration of the door guide latch slot assembly of the present invention in a partially assembled configuration and with a striker plate at the limit of its adjustable range.

FIG. 5 is an illustration of the present invention with an electromechanical alarm assembly.

FIG. 6 is an illustration of the present invention with a mechanical locking assembly.

Like numerals refer to like parts throughout the several views of the drawings.

### DETAILED DESCRIPTION OF THE PREFERRED EMBODIMENTS

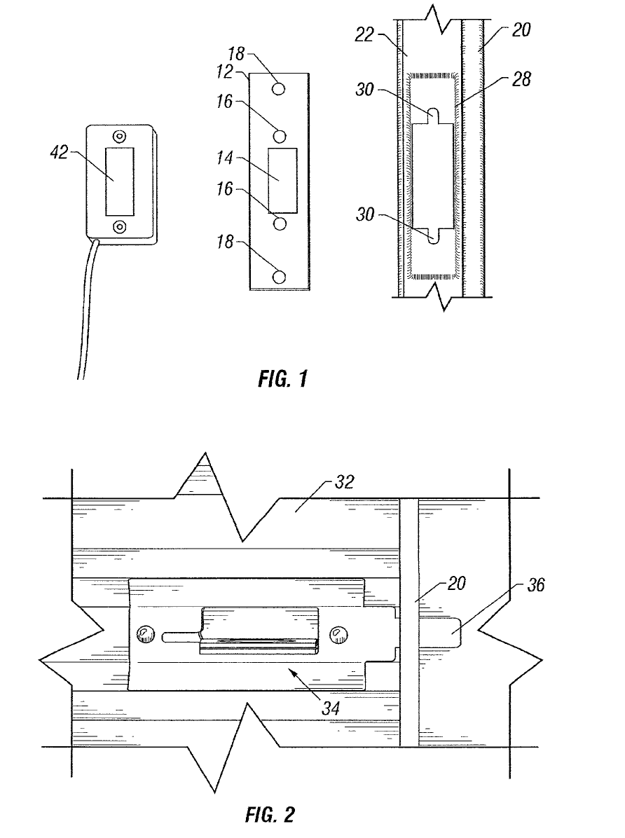

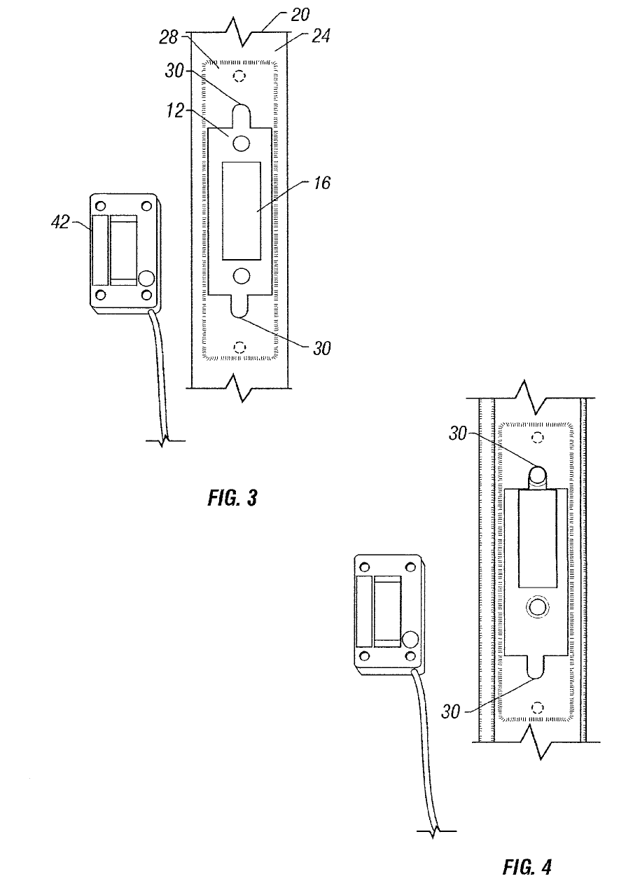

Referring to FIGS. 1-3, a first embodiment of an adjustable door guide latch slot assembly 10 is shown.

The latch slot assembly 10 includes a striker plate 12 having a latch tongue opening 14 and inner and outer sets of fastener openings, 16 and 18, respectively. Also included is door guide 20 which has an inner surface 22, an outer surface 24 and a door guide cut-out opening 26. Door guide cut-out opening is located entirely within a recessed portion 28 of door guide inner surface 22 and has at either end a pair of alignment slots 30.

The door guide latch slot assembly 10 of the present invention works in conjunction with a vertical door 32 having a slidable latch assembly 34. The slidable latch assembly 34 is equipped with a latch tongue 36 that may be articulated back and forth within slidable latch assembly 34. When the vertical door 32 is fully closed, latch tongue 36 may be moved toward door guide opening 26. In a preferred embodiment, striker plate 12 is placed against door guide inner surface 22 in recessed portion 28 and is aligned within recessed portion 28 so that latch tongue 36 can pass through striker plate latch tongue opening 14 to extend beyond door guide outer surface 24. Once the proper positioning is determined for latch tongue 36 to pass through striker plate 12, striker plate 12 is affixed to door guide 20 by using appropriate fasteners placed through the outer set of fastener openings 18 in striker plate 12. In a preferred embodiment, self-drilling/self-tapping fasteners may be driven through door guide 20 and then passed through striker plate outer fastener openings 18 to affix striker plate 12 in position. It is to be understood, however, that any type of appropriate fastener may be used to affix striker plate 12 into the proper position to accommodate latch tongue 36.

The adjustment range for striker plate 12 is limited only by the outer limits of alignment slots 30 in door guide cut-out opening 26. As best illustrated in FIG. 4, in a preferred embodiment of the present invention striker plate latch tongue opening 14 has an approximate 1-inch total adjustment range. Although this range should be sufficient to accommodate alignment of latch tongue 36 with striker plate latch tongue opening 14 under even the most adverse installation conditions of vertical door 32 and door guide 20, it is to be understood that the present invention is not limited to a 1-inch adjustment range, but includes larger adjustment ranges as may be needed in given situations. For example, for extremely large vertical doors, as may be used on warehouses, aircraft hangars, or other large structures, a larger adjustment range may be appropriate.

In a preferred embodiment, striker plate 12 when placed in recessed portion 28 of door guide 20 is sufficiently recessed so as to not interfere with the movement of door wheels (not shown) that may be present on vertical door 32. In other words, the depth of recessed portion 28 is approximately equal to, but no less than the thickness of striker plate 12, so as to allow smooth functioning of door wheels as they pass over the portion of door guide inner surface 22 where striker plate 12 is located.

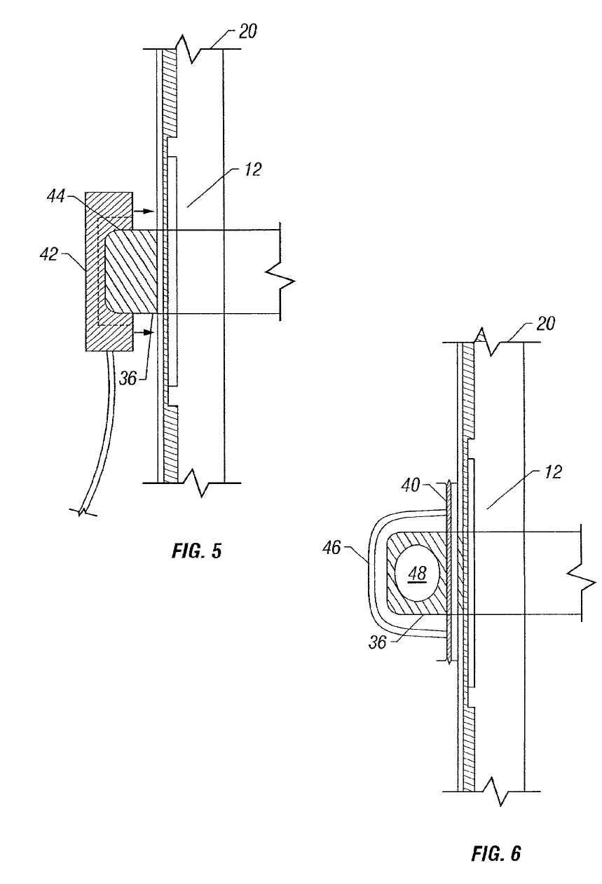

In yet another preferred embodiment of the present invention, striker plate 12 may accommodate the attachment thereto of a security mechanism such as a mechanical lock assembly 40 or an electromechanical alarm assembly 42. By way of example and not limitation, an electromechanical alarm assembly such as that disclosed in U.S. Pat. No. 6,124,792 may be used in conjunction with the adjustable door guide latch slot assembly 10 of the present invention. As best illustrated in FIG. 5, the alarm assembly 42 may be equipped with a latch tongue receiving port 44 for receiving latch tongue 36 after it passes through striker plate latch tongue opening 14 and door guide opening 26. The introduction of latch tongue 36 into latch tongue receiving port 44 engages an electromagnetic alarm system as disclosed in U.S. Pat. No. 6,124,792. For proper functioning of this alarm system, however, latch tongue receiving port 44 must be properly aligned with latch tongue 36. To accomplish this alignment, the present invention includes striker plate inner fastener openings 16 which permit alarm assembly 42 to be affixed to striker plate 12 and thereby move alarm assembly 42 with striker plate 12 as striker plate 12 is adjusted within recessed portion 28 to accommodate the position of latch tongue 36. Accordingly, the present invention provides for precise alignment of not only striker plate latch tongue opening 14 with latch tongue 36, but also between latch tongue 36 and latch tongue receiving port 44.

In yet another preferred embodiment of the present invention, other security means than an electromechanical alarm assembly may be affixed to striker plate inner fastener openings 16. For example, as shown in FIG. 6, a mechanical lock assembly 40 with plate having a closed metallic half-loop 46 may be affixed to striker plate 12 at fastener openings 16 and, if latch tongue 36 is equipped with an opening 48 in its end, a padlock or other security mechanism may be passed through the metallic half-loop 46 and latch tongue opening 48 to provide a secure locking of latch tongue 36 with door guide 20, thereby preventing vertical door 32 from being opened. The proper adjustment of striker plate 12 in conjunction with latch tongue 36 will guarantee proper alignment of latch tongue opening 48 with loop 46.

The embodiments of the present invention recited herein are intended to be merely exemplary and those skilled in the art will be able to make numerous modifications to them without departing from the spirit of the present invention. For example, different types of fasteners may be used to affix striker plate 12 to door guide 20, as well as to affix alarm assembly 42 to striker plate 12. Similarly, the range of adjustment available for striker plate 12 within door guide recessed portion 28 may be made to be larger or smaller, depending upon the particular application for the present invention. All such modifications are intended to be within the scope of the present invention, as defined by the claims appended hereto.

What is claimed is:

1. An adjustable door guide latch slot assembly for aligning a slidable door latch with a fixed door guide comprising a striker plate having a latch opening therein, and a door guide having an inner surface and having an opening therein with said opening being larger than said striker plate latch opening, whereby said striker plate may be adjustably affixed to said door guide inner surface so that said striker plate latch opening aligns with said slidable door latch.

2. The adjustable latch slot assembly of claim 1, further comprising a recessed area on said door guide inner surface that is large enough so that said striker plate may be placed flat within said recessed area.

3. The adjustable latch slot assembly of claim 2 wherein the depth of said recessed area is at least as great as the thickness of said striker plate.

4. The adjustable latch slot assembly of claim 1 wherein said door guide opening has alignment slots for accommodating various positions of placement of said striker plate against said door guide inner surface.

5. The adjustable latch slot assembly of claim 2 wherein said door guide opening has alignment slots for accommodating various positions of placement of said striker plate against said door guide inner surface.

6. The adjustable latch slot assembly of claim 3 wherein said door guide opening has alignment slots for accommodating various positions of placement of said striker plate against said door guide inner surface.

7. The adjustable latch slot assembly of claim 2 wherein said striker plate has a first set of fastener openings for receiving fasteners to affix said striker plate to said door guide.

8. The adjustable latch slot assembly of claim 3 wherein said striker plate has a first set of fastener openings for receiving fasteners to affix said striker plate to said door guide.

9. The adjustable latch slot assembly of claim 4 wherein said striker plate has a first set of fastener openings for receiving fasteners to affix said striker plate to said door guide.

10. The adjustable latch slot assembly of claim 6 wherein said striker plate has a first set of fastener openings for receiving fasteners to affix said striker plate to said door guide.

11. The adjustable latch slot assembly of claim 1 further comprising a security device having a latch port for accepting said door latch whereby said security device is affixed to said adjustable striker plate to accommodate the position of said door latch.

12. The adjustable latch slot assembly of claim 3 further comprising a security device having a latch port for accepting said door latch whereby said security device is affixed to said adjustable striker plate to accommodate the position of said door latch.

13. The adjustable latch slot assembly of claim 4 further comprising a security device having a latch port for accepting said door latch whereby said security device is affixed to said adjustable striker plate to accommodate the position of said door latch.

14. An adjustable door guide latch slot assembly for aligning a slidable door latch with a fixed door guide comprising a striker plate having a latch opening therein and a door guide having an inner surface with a recessed area on said inner surface said recessed area being larger than said striker plate and having an opening therein with said opening being larger than said striker plate latch opening, whereby said striker plate may be placed flat against said door guide inner surface in said recessed area and adjustably affixed to said door guide inner surface so that said striker plate latch opening aligns with said slidable door latch.

15. The adjustable latch slot assembly of claim 14 wherein the depth of said recessed area is at least as great as the thickness of said striker plate.

16. The adjustable latch slot assembly of claim 15, whereby said door guide opening has alignment slots for accommodating various positions of said striker plate against said door guide inner surface.

17. The adjustable latch slot assembly of claim 16 further comprising a first set of fastener openings in said striker plate for affixing said striker plate to said door guide.

18. The adjustable latch slot assembly of claim 17 further comprising a security device having a latch receiving port for accepting said door latch whereby said security device is affixed to said adjustable striker plate so that said security device latch receiving port aligns with said slidable door latch.

19. An adjustable door guide latch slot assembly for aligning a slidable door latch with a fixed door guide comprising:
a striker plate having a latch opening therein;
a door guide having an inner surface with a recessed area larger than said striker plate and having an opening therein with said opening being larger than said striker plate latch opening; and
a security device having a latch receiving port,
whereby said striker plate may be placed flat against said door guide inner surface within said recessed area and may be adjustably affixed to said door guide inner surface so that said striker plate latch opening aligns with said slidable door latch and whereby said security device is affixed to said adjustable striker plate so that said latch receiving port aligns with both said striker plate latch opening and said slidable door latch.

20. The adjustable latch slot assembly of claim 19 wherein the depth of said recessed area is at least as great as the thickness of said striker plate.

21. The adjustable latch slot assembly of claim 20 wherein said door guide opening further comprises alignment slots for accommodating various positions of said striker plate against said door guide inner surface.

22. A method of adjustably aligning a latch slot in a fixed door guide with a slidable door latch comprising the steps of:
providing a striker plate having a latch opening therein; and
providing a door guide having an inner surface and having an opening therein with said opening being larger than said striker plate latch opening,
whereby said striker plate may be adjustably affixed to said door guide inner surface so that said striker plate latch opening aligns with said slidable door latch.
